(19) United States
(12) Patent Application Publication
(10) Pub. No.: US 2022/0026088 A1
(43) Pub. Date: Jan. 27, 2022

(54) GEOFENCING-ENHANCED MONITORING OF AIR FILTERS

(71) Applicant: 3M INNOVATIVE PROPERTIES COMPANY, St. Paul, MN (US)

(72) Inventors: Michael A. Meis, Cushing, MN (US); Patrick S. Hiner, Woodbury, MN (US); Nicolas A. Echeverri, Woodbury, MN (US)

(21) Appl. No.: 17/296,525

(22) PCT Filed: Dec. 18, 2019
(86) PCT No.: PCT/IB2019/061036

§ 371 Date: May 24, 2021

Related U.S. Application Data
(60) Provisional application No. 62/781,830, filed on Dec. 19, 2018.

(51) Int. Cl. F24F 11/39; H04W 4/021; H04W 4/80; G08C 17/02; F24F 11/58

(52) U.S. Cl. CPC F24F 11/39; H04W 4/021; F24F 2110/40; G08C 17/02; F24F 11/58; H04W 4/80

(57) ABSTRACT

A method of monitoring the condition of an air filter installed in an HVAC system of a building unit. The method involves two-way wireless communication between a sensing unit that is mounted within the HVAC system and a geofencing-enabled app that is resident on a mobile device. Wireless signals between the sensing unit and the mobile device pass through an interior passage of ducting of the HVAC system with the interior passage of the ducting acting as a waveguide. The geofencing-enabled app is configured so that the app is triggered to open communication with the sensing unit upon the mobile device entering a geofencing boundary that is at least generally coincident with lateral boundaries of the building unit.

### BACKGROUND

Heating, ventilation, and air conditioning (HVAC) systems are commonly used to control temperature in the occupied spaces of buildings. With many HVAC installations, a disposable air filter is conventionally employed. Such filters often include a frame and filter media. After a period of use, the filter media may become dirty or clogged and should be replaced for optimum performance.

### SUMMARY

In broad summary, herein is disclosed a method of monitoring the condition of an air filter installed in an HVAC system of a building unit. The method involves two-way wireless communication between a sensing unit that is mounted within the HVAC system and a geofencing-enabled app that is resident on a mobile device. Wireless signals between the sensing unit and the mobile device pass through an interior passage of ducting of the HVAC system. The geofencing-enabled app is configured so that the app is triggered to open communication with the sensing unit upon the mobile device entering a geofencing boundary that is at least generally coincident with lateral boundaries of the building unit. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary building unit and an HVAC system that services the building unit, shown in idealized, generic representation.

FIG. 2 is a side perspective view of an exemplary HVAC system for a building unit, shown in idealized, generic representation.

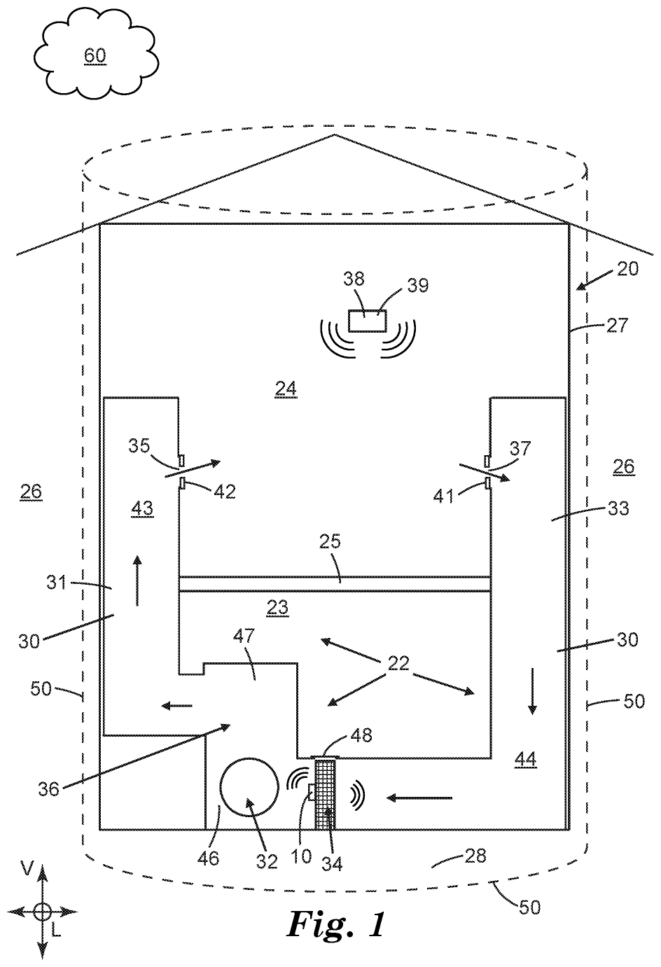

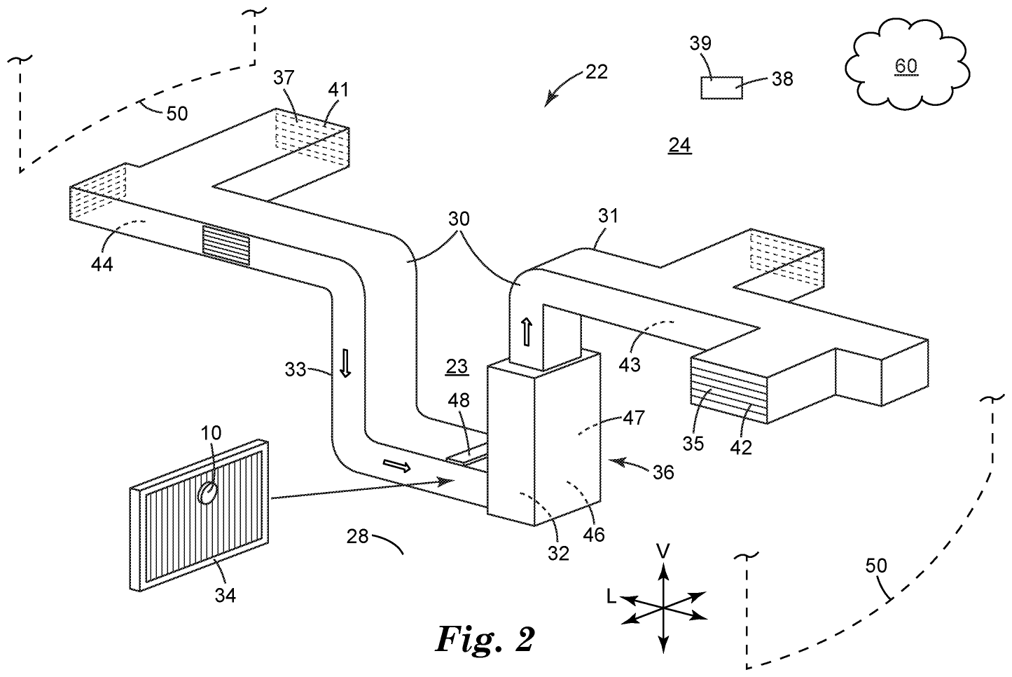

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “outward”, “inward”, “up” and “down”, and “first” and “second” may be used in this disclosure, it should be understood that those terms are used in their relative sense only unless otherwise noted. Terms such as “top”, “bottom”, “upper”, “lower”, “under”, “over”, “above”, “below”, and “up” and “down” have their ordinary meaning with respect to a vertical axis aligned with the Earth's gravity, as indicated by axis V in FIGS. 1 and 2. The term “lateral” denotes any axis that is orthogonal to the vertical axis (i.e. that is horizontal along any compass direction) as indicated by axis L in FIGS. 1 and 2.

The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter.

### DETAILED DESCRIPTION

The present disclosure relates to systems and methods for monitoring the condition of an air filter in an HVAC system of a building unit. Although the term “HVAC” is used for convenience, it is emphasized that such a system need only be configured to perform at least one of heating and cooling; the system need not necessarily be capable of performing both functions although many such HVAC systems will do so.

FIG. 1 schematically illustrates a building unit 20 having an installed HVAC system 22 (referenced generally). While building unit 20 is shown in FIG. 1 in the general form of a single-family dwelling (e.g. a residential house), it is emphasized that FIG. 1 is a generic, idealized representation for purposes of illustration. In general, a building unit 20 may be any enclosed structure or portion thereof, in which, for example, one or more persons live, temporarily reside, work, study, perform leisure activities, store belongings, and so on. A building unit 20 may be a single-family home (whether single-story or multi-story) or a duplex, triplex, townhouse or condominium that e.g. shares at least one wall with an adjoining unit. A building unit 20 may be a commercial or government enterprise (whether in a stand-alone building or occupying a portion of a building) such as a retail store, an office, a post office, and so on. It is thus understood that the term building unit is used for convenience to broadly denote any such entity, whether stand-alone or occupying a portion of a building.

At least a portion of the building unit 20 will be an occupied space 24 that is temperature-controlled by way of HVAC system 22 and that is thus supplied with temperature-controlled air by at least one air-delivery outlet as described below. In many instances, an occupied space 24 may take the form of multiple rooms. A building unit 20 will often comprise at least one exterior wall 27 that generally separates or isolates indoor air in occupied space 24 from outdoor air in an external environment 26. Such exterior walls (and any walls that may be shared with an adjoining unit) will collectively serve to establish the lateral boundaries of the building unit.

Many such building units comprise an HVAC system, i.e. a forced-air system that serves to heat and/or to cool the indoor air in occupied space 24. As indicated in exemplary manner in FIGS. 1 and 2, such an HVAC system 22 often relies on a heating and/or cooling unit 36. Such a unit, if used for heating, may include a combustion furnace operating on e.g. natural gas, propane or fuel oil; or it may include an electrical heater, a heat pump, and so on. Such a unit, if used for cooling, may comprise evaporator coils connected to an external condensing unit and whose operation will be well understood. Such a heating and/or cooling unit 36 will be referred to generically as a temperature-control unit; it will be understood that such terminology encompasses any unit that only heats, that only cools, or that is capable of performing heating or cooling as desired. Such a unit 36 may comprise a blower fan 32 located in a fan compartment 46, and a heat exchange compartment 47 containing e.g. heat exchangers and/or electrical resistance heaters, and/or containing evaporator coils.

HVAC system 22 further comprises ducting 30 that includes air-delivery ducting 31 via which temperature-controlled air (e.g. heated or cooled air) is delivered, as motivated by fan 32, into occupied space 24. Conventionally, this is done by equipping air-delivery ducting 31 with one or more air-delivery outlets 35, which are often fitted into an opening in a wall of an occupied space and which are often fitted with registers 42. Ducting 30 often further comprises air-return ducting 33 via which air is returned to temperature-control unit 36 from occupied space 24. (Delivery and return of air is indicated by the various arrows in FIGS. 1 and 2.) Conventionally, one or more air-return inlets 37 are provided for this purpose, which are often fitted into an opening in a wall of an occupied space and are often fitted with grilles 41. The terminology herein reflects the common convention in which air-delivery registers are fitted with openable/closeable/adjustable louvers and in which air-return grilles comprise non-adjustable permanent openings, as will be well understood. However, it is noted that any grille or register, or any suitable type, may be provided on any desired air-delivery outlet or air-return inlet.

As shown in exemplary embodiment in FIG. 2, air-delivery ducting 31 of an HVAC system 22 often comprises a main air-delivery plenum or trunk that receives air exiting temperature-control unit 36 and that may split into several air-delivery ducts that distribute the air to different rooms of the occupied space of the building unit. Such ducts are often routed underneath a floor (e.g. floor 25 of FIG. 1), up through the internal spaces between walls, and so on, as will be familiar to any homeowner. Any such air-delivery ducting 31, regardless of the particular configuration, will define an interior passage 43 (which passage may often be elongate and/or serpentine) 43 through which temperature-controlled air passes to be delivered to occupied space 24. Similarly, air-return ducting 33 often comprises several air-return ducts that join into a main air-return trunk or plenum from which fan 32 pulls air into temperature-control unit 36. Any such air-return ducting 33, regardless of the particular configuration, will define an interior passage 44 through which air collected from occupied space 24 is returned to temperature-control unit 36. It will be appreciated that many modern temperature-control units utilize a fan (e.g. a variable speed fan) that may continue to run, e.g. at a lower speed, even when the temperature-control unit is not actively heating or cooling. Thus the concept of air-delivery ducting does not necessarily require that the air that is delivered therethrough, must necessarily be temperature controlled at all times.

One or more thermostats or similar controllers may dictate operation of the HVAC system 22, such as by activating fan 32 and/or other components of temperature-control unit 36 (e.g. a gas-fed furnace) in response to various conditions, such as sensed indoor temperature. One or more air filters 34 are typically provided in order to filter the air that passes through HVAC system 22. Such an air filter serves a basic purpose of minimizing the amount of airborne debris (e.g. hair, carpet fibers, clothing lint, and so on) that reaches temperature-control unit 36. As such, an air filter 34 is typically installed in the main air-return trunk of air-return ducting 33, upstream of temperature-control unit 36, typically at a location fairly close to (e.g. within a meter of) temperature-control unit 36. However, in recent years, such air filters 34 have been engineered to not only protect temperature-control unit 36 from airborne debris, but to also remove undesired materials (e.g. fine particles such as dust, pollen, pet dander, and so on) from the air. Thus, monitoring the condition of such air filters has become increasingly important. In particular, an indication of the amount of particulate matter that has accumulated in the filter media has become an increasingly useful parameter to monitor. Thus in the present disclosure, at least one sensing unit 10 is provided as shown in exemplary manner in FIGS. 1 and 2 to enable monitoring of the air filter, as discussed in detail later herein.

In many instances, temperature-control unit 36 and at least a portion of ducting 30 (e.g. at least portions of air-return ducting 33 and air-delivery ducting 31) are located in a machinery space 23, as indicated in exemplary embodiment in FIG. 1. In many instances such a machinery space 23 is not a part of an occupied space 24. Rather, in some instances a machinery space 23 may be located in a basement or crawl space of a building unit (or, somewhat less commonly, in an attic or a utility closet of the building unit), and may often be separated from an occupied space 24 by at least one floor 25 and/or at least one wall. In various circumstances, a machinery space may comprise the entirety of a basement or it may occupy only a portion of a basement with another portion of the basement being finished to serve e.g. as an occupied space. A machinery space may often comprise additional entities in addition to temperature-control unit 36 and associated ducting; for example, such a space may comprise one or more of a water heater, a humidifier, and so on. Again, it is emphasized that FIG. 1 is a simplified representation for purposes of illustration and that in actuality an enormous variety of building units, with a wide variety of configurations of occupied spaces and machinery spaces, are found.

As disclosed herein and as indicated in exemplary manner in FIGS. 1 and 2, a sensing unit 10 is provided that allows the condition of air filter 34 to be monitored. In many embodiments such a sensing unit may be located within ducting 30 in close proximity to (e.g. within one meter of) air filter 34. In particularly convenient embodiments such a sensing unit may be located on (e.g. attached to), and provided in combination with, the air filter that the sensing unit is used to monitor. In specific embodiments, such a sensing unit may comprise a pressure sensor and may be located downstream of air filter 34 (i.e., between air filter 34 and fan 32 of unit 36). Such a sensing unit can monitor the pressure (partial vacuum) that is established by fan 32 in the act of drawing air through air filter 34. Monitoring of this pressure over time can allow the amount of particulate matter that has accumulated in the filter media of air filter 34 to be estimated and can thus be used to provide an indication of the remaining usable filter life. Possible configurations and arrangements and methods of using sensing units of this general type are described in detail in U.S. Provisional Patent Application No. 62/374,040 which is incorporated by reference in its entirety herein. Such arrangements are also described in the published (PCT) patent application designated as International Publication No. 2018/031403; and, in the resulting U.S. national stage (371) patent application No. __/______ (Attorney Docket Number 79848US011), both entitled Air Filter Condition Sensing and both of which are incorporated by reference in their entirety herein.

It is convenient for such a sensing unit 10 to be able to wirelessly communicate with a mobile device (e.g. a smartphone, a tablet computer, laptop computer, or the like) 38 in order to perform the desired monitoring function. In various embodiments, sensing unit 10 may transmit raw or processed data so that a program (e.g. an app) 39 residing on the mobile device 38 can use the data to reach an indication of the filter condition. The data may be used solely by the mobile-device-resident app; or, the app may forward the data to a cloud-based server 60 with which the mobile device is in communication, to reach the indication of the filter condition. Such arrangements are discussed in detail in the above-referenced applications. Or, in some embodiments the sensing unit itself may process the data and transmit a resulting indication of the filter condition to the mobile device.

Regardless of the specific configuration, such arrangements typically require that the sensing unit 10 be able to wirelessly communicate with a mobile device 38. Such wireless communication may be conveniently facilitated by way of, for example, a Bluetooth or Low Energy Bluetooth radio broadcaster/receiver present on sensing unit 10. However, in the present work it has been appreciated that a sensing unit 10 that is located in close proximity to air filter 34 (e.g. that is mounted on a downstream face of air filter 34 as in FIGS. 1 and 2) may, in many instances, be essentially trapped in a Faraday cage established by the HVAC system. That is, ducting 30 (including any plenums, trunks and distribution ducts), as well as the panels of temperature-control unit 36, are typically comprised of sheets of an electrically conductive material such as e.g. mild steel. A sensing unit 10 positioned in the general manner indicated in FIGS. 1 and 2 will thus be located so that an electromagnetic signal propagating in any direction from the sensing unit will encounter a conductive surface or layer of a sidewall, ceiling or floor of a ducting component, a conductive surface or layer of a panel of unit 36, or the ground 28 (e.g. a concrete slab) beneath the ducting, before encountering any opening through which the electromagnetic signal can escape the HVAC system. Typically, even an opening (e.g. a slot) which allows the air filter 34 to be inserted into the ducting, is closed with a metal cover 48 after the air filter is installed, as indicated in FIGS. 1 and 2.

It would thus be expected that this shielding of sensing unit 10 would cause HVAC system 22 to act as a Faraday cage (e.g. a grounded Faraday cage) that, in many instances, would at least substantially attenuate any electromagnetic signal emitted by sensing unit 10 before the signal is able to reach a mobile device 38 located outside of the HVAC system. Thus for example in the exemplary HVAC system 22 shown in FIG. 2, there is no direct route by which an electromagnetic signal emitted by sensing unit 10 can escape the HVAC system without first encountering a floor, ceiling or sidewall of ducting 30 or of temperature-control unit 36. Similarly, HVAC system 22 would be expected to substantially attenuate any electromagnetic signal from a mobile device 38 before the signal is able to reach sensing unit 10.

Such phenomena would be expected to be exacerbated by the fact that air filter 34 (and thus sensing unit 10) is typically located within a machinery space 23, with the result that in many cases, any such electromagnetic signal would have to pass through one or more floors and/or walls (in addition to escaping the Faraday cage established by the HVAC system) to reach mobile device 38. Thus it might reasonably be expected that a mobile device 38 would have to be brought into close proximity to sensing unit 10 in order to establish an adequate connection between sensing unit 10 and the mobile device. This would require that a user of mobile device 38 must enter machinery space 23 in order to achieve such communication. Since machinery space 23 may often be located in a basement (or even in a crawl space that is only accessible from outside the building unit) this can present difficulties in conveniently using sensing unit 10 and mobile device 38 in combination to monitor the condition of air filter 34. In other words, such arrangements might require the user to remember to periodically bring the mobile device 38 into the machinery space 23 and into close proximity to sensing unit 10 in order for the condition of the air filter to be monitored.

Waveguide Effect

The present work has revealed that such difficulties can be mitigated, and in many instances appear to be able to be avoided completely, by taking advantage of the properties of the HVAC system. Specifically, it has been found that since the ducting of an HVAC system is typically constructed of conductive materials such as steel, the interior passages (e.g. 43 and 44) of the HVAC ducting can act as waveguides through which electromagnetic signals emitted by sensing unit 10 can propagate, at least at the frequencies (e.g. 2.4 GHz) commonly used in short-range wireless communication. This allows the signals to reach an occupied space 24 through an air-delivery outlet 35 or an air-return inlet 37 so that the signals can then reach a mobile device 38 located in occupied space 24.

The fact that in many cases at least a substantial portion (e.g. greater than 50, 70, 90, 95, or 98%) of the emitted signals are propagated through the interior passages of the HVAC ducting (rather than e.g. penetrating directly through the ducting sidewalls/ceilings/floors and through any intervening floors and/or walls) has been verified experimentally by comparing signal strength in locations in close proximity to air inlets and/or outlets to the signal strength in locations far removed from the air inlets and outlets, as presented in detail in the Working Examples herein. Based on these findings, it can be considered that an HVAC ducting is acting as a waveguide for delivery of wireless signals between the sensing unit and the mobile device, if the signal strength measured in a location proximate (e.g. within 4 cm of) an HVAC inlet or outlet that serves an occupied space, is greater than the signal measured in a location of the occupied space that is greater than 3 meters away from the inlet or outlet, by at least 3 dB. In various embodiments, the method may provide that the signal strength measured in a location proximate an HVAC inlet or outlet that serves an occupied space, is greater than the signal measured in a location that is greater than 3 meters away from the inlet or outlet, by at least 5 dB, at least 10 dB or at least 15 dB.

In further detail, it has been found that even the presence of a metal grille 41 or register 42 at an air-return inlet 37 or an air-delivery outlet 35 does not unacceptably block the electromagnetic signals. Furthermore, it has been found that such signals are able to propagate through air-delivery ducting rather than only through air-return ducting. It will be appreciated that due to the placement of the air filter (and thus the sensing unit), this requires that the signals must pass through the fan compartment 46 and the heat-exchange compartment 47 of the temperature-control unit 36. Apparently the signals are able to do this without the heat-exchange tubes, baffles or resistance heating elements (and any evaporator coils if present) in the heat-exchange compartment acting as a ground plane to drastically attenuate the signal.

Still further, it has been found that the above-described arrangements are effective not merely for signals that are emitted by the sensing unit and propagated along the ducting and emitted from a ducting inlet or outlet into an occupied space to be received by a mobile device. Rather, such an arrangement is also effective for signals that are emitted by the mobile device. That is, such signals are able to penetrate into a ducting inlet or outlet (which may occupy only a very small portion of the area of the occupied space within which the mobile device is broadcasting) and from there to be propagated through the interior passages of the ducting to reach the sensing unit.

In other words, it has been found that an HVAC system can do more than merely propagate signals that originate inside an interior passage of the ducting (and which are thus already within the waveguide as they are generated) and emit them through a ducting inlet or outlet. Rather, the HVAC system can function to gather signals that originate outside the ducting and can then guide the signals down an interior passage of the ducting. Thus, the arrangements disclosed herein allow two-way communication between the sensing unit and the mobile device.

In summary it has been found that a sensing unit positioned in proximity to an air filter of a forced-air HVAC system (e.g., positioned in the general manner shown in FIGS. 1 and 2) can be used in combination with a mobile device without necessitating that the mobile device be brought into close proximity to the sensing unit; in particular, without the mobile device needing to be introduced into a machinery space in which the sensing unit is located. This provides considerable advantages in that a resident (or other mobile-device-bearing-person) need merely be present in the occupied space 24 of the building unit in order for two-way communication to be established between the sensing unit and the mobile device. The person does not need to remember, or be reminded, to make a special trip to the machinery space to ensure that the sensing unit and mobile device are able to communicate with each other.

In some building units, an air filter may be located e.g. behind an air return grill in an occupied space. In such instances, a sensing unit that is mounted in close proximity to the air filter may not necessarily be trapped in a Faraday cage to the extent described above. That is, signals emitted by the sensing unit may be able to enter that particular occupied space without hindrance by the HVAC ducting. However, the arrangements disclosed herein can still advantageously allow that a mobile device does not necessarily have to be taken into that particular occupied space in order for the mobile device to communicate with the sensing unit. Rather, the HVAC ducting may act as a waveguide as described above, to allow communication to occur from any occupied space of the building unit.

The discussions above reveal that positioning a sensing unit within an HVAC system that acts as a waveguide for electromagnetic signals emitted by the sensor (or to be received by the sensor) can achieve advantageous effects. For example, HVAC ducting usually extends to all of the occupied spaces of a building unit, including spaces that are near an exterior wall of the building unit. Thus, the HVAC ducting can allow communication to be established throughout the occupied spaces, out to the exterior walls (i.e. the “envelope”) of the building unit. The exterior walls may of course attenuate the electromagnetic signals to an extent that in many instances the signals may not extend significantly far beyond the exterior walls of the building unit. (This discussion uses the example of a single-family residence; similar considerations hold for e.g. wall-sharing duplexes, condominiums or the like, that are served by a separate HVAC systems that do not interconnect.)

Geofencing

Such arrangements can be enhanced by equipping the mobile device 38 that is used in combination with the sensing unit 10, with geofencing capability. Specifically, an app 39 that is resident on the mobile device 38 and that serves along with the sensing unit 10 to facilitate the monitoring of the air filter 34, can be a geofencing-enabled app; i.e., an app that is configured with a geofencing functionality that works in combination with a location-services capability of the mobile device. Such a geofencing functionality will be configured to establish a geofencing boundary (occasionally referred to herein as a geofence) that is at least generally coincident with the lateral boundaries (e.g. external walls) of the building unit. A geofencing boundary 50 is shown in generic representation in FIG. 1; it will be understood that such a boundary serves to divide areas laterally within the boundary from areas laterally outside the boundary; the boundary extends vertically upward and is not limited in this aspect. The use of such a geofence can provide that, for example, the mobile-device-resident app 39 can refrain from attempting to wirelessly contact the sensing unit when the mobile device 38 is outside the geofencing boundary 50. Entry of the mobile device into the geofencing boundary can then trigger the app to attempt to open wireless communication with the sensing unit. (This can be done in various ways which are discussed in detail later herein.)

The geofencing capability can provide that the app does not necessarily have to be visible to the user (e.g. in an open/foreground state or even in an open/background state, as discussed in detail later herein) in order for the app to communicate with the sensing unit. Furthermore, the user of the app does not have to remember to manually turn on the app, or leave the app on, when the user is within the building unit in order to facilitate such communication. Still further, the app need not be set up to attempt wireless communication with the sensing unit on a timed-based schedule (which, after all, may not necessarily correspond to times in which the user of the mobile device is within the building unit). Rather, the app can be triggered to open communication with the sensing unit by the act of entering the geofence, which can ensure that the attempted communication occurs only when the mobile device is likely to be inside the building unit and able to communicate with the sensing unit. This can, for example, reduce the number of times that the app fruitlessly attempts to contact the sensing unit while not within range of the sensing unit, can advantageously preserve the battery life of the mobile device, and so on.

Thus in summary, the use of a geofencing boundary that is tightly constrained around a building unit as disclosed herein can limit the times at which the app attempts to open communications with a sensing unit to times in which the mobile device is likely to actually be somewhere inside the building unit. And, the above-described use of the HVAC system as a waveguide provides that communication can be established throughout much or all of the occupied spaces of the building unit, including spaces close to the lateral boundaries of the building unit. The leveraging of the waveguiding properties of an HVAC system, and the use of a tightly-constrained geofence, thus act in synergy.

The actions of a user entering the building unit and moving from room to room (with the mobile device) in the course of normal activities can provide that, in at least some embodiments, the desired communication between the sensing unit and the mobile-device-based app can occur in a manner that is largely or even completely transparent to the user. Still further, this communication can occur repeatedly, e.g. once per hour, once per day, and so on, in order that the desired data transfer between the sensing unit and the mobile device is achieved, again while being transparent to the user and requiring no action by the user. Thus, once a sensing unit and a mobile device are paired to each other, the user can, for example, leave the app in a first, less active state (that, for example, may be an open/background state or may be a closed state, as discussed in detail later herein), with the geofencing functionality able to activate the app to a second, more active state upon entering the geofenced area so that the desired communication/data transfer can occur. After pairing, the next time that the user interacts with the app (or indeed even notices the app) may be e.g. when the app generates a notification of the remaining usable life of the air filter. (Of course, in various embodiments the app may allow the user to set the increments of remaining filter life of which the user wishes to be informed.) The arrangements disclosed herein thus operate to allow monitoring of the condition of an air filter with minimum effort and interaction on the part of a user.

As noted above, a geofencing boundary may be established that is at least generally coincident with the lateral boundaries of the building unit. Geofences are typically specified in terms of the centerpoint and radius of the geofence. By generally coincident is meant that the centerpoint and radius of the geofence are set so that at least 20% of the geofenced area overlaps the space within the lateral boundaries of the building unit when viewed along a vertical axis. That is, for the example of a single-family house, at least 20% of the area defined by (within) the geofence will overlap an area bounded by the external walls of the house. In some embodiments the geofence may be configured to be at least substantially coincident with the lateral boundaries of the building unit, meaning that the centerpoint and radius of the geofence are set so that at least 50% of the geofenced area overlaps the laterally-bounded space of the building unit. In further embodiments, at least 70, 90, or 100% of the geofenced area overlaps this space. In many embodiments the centerpoint of the geofence may be located within the lateral boundaries of the building unit. In various embodiments, if outside the lateral boundaries of the building unit, the centerpoint may be located within 100, 40, 20, or 10 meters of the nearest lateral boundary of the building unit.

In various embodiments, the app may be configured so that the geofence has a radius of at most 100, 80, 60, 40, 30, 20, 15, or 10 meters. In further embodiments, the app may be configured so that the geofence has a radius of at least 5, 8, 13, 25, 35, 45, 55, 70, or 90 meters. In some embodiments the geofence radius may be not be user-adjustable. In some such embodiments, the radius may be factory-set and unchangeable; in other such embodiments the radius, while not being user-adjustable, may be administrator-adjustable e.g. as part of a software update or the like. In some embodiments the geofence radius may be adjustable by the user. (Although the geofence centerpoint and/or radius may be stored as parameters within the location services functionality of the operating system of the mobile device, in many convenient embodiments one or both of them may be entered through an interface presented by the app.)

In many instances the centerpoint of the geofence may be located in close proximity to the geometric center of the building unit, e.g. as in the exemplary representation of a geofence 50 in FIG. 1. However, many apps allow a user to choose the centerpoint of a geofence e.g. by dropping a pin on a map, by entering a street address, by entering a set of longitude-latitude coordinates, or the like. And, of course, the size and shape of building units can vary considerably. Thus in some cases the centerpoint of a geofence may not coincide as exactly with the geometric center of a building unit as in the idealized representation of FIG. 1. In view of such considerations, the above-listed ranges regarding the centerpoint and radius of the geofence are considered to be those best suited for many single-family homes, townhouses, duplexes and condos, for retail or light commercial establishments, and so on. It will be appreciated that in some instances a building unit (even a single-family home) can be quite large; in such cases the geofenced area may fall completely within the lateral boundaries of the building unit. This is acceptable since, typically, movements of the user throughout the interior of the building unit will ensure that the mobile device is at least occasionally (e.g. once per day, which should be ample) brought within the boundaries of the geofence.

The arrangements disclosed herein can be conveniently achieved by the use of an “app” resident on a mobile device, e.g. smartphone, tablet computer, personal digital assistant (PDA), laptop computer, and so on. (In this context, a desktop computer that spends much or all of its time at a single location and is not normally transported from place to place in ordinary use, would not be considered a mobile device.) Such an app, and the sensing unit that is used therewith, can be configured to operate according to any desired arrangement. Various possible modes of operation are detailed below in various exemplary embodiments; any such arrangement or suitable combination thereof may be used.

Upon a mobile device entering a geofencing boundary that is at least generally coincident with lateral boundaries of a building unit, a geofencing-enabled app will be triggered to open communication with a sensing unit that is resident within the building unit. This opening of communication by the app can occur in either passive mode or active mode. In passive mode, entering the geofence triggers the app to wait to receive a wireless query signal from the sensing unit. In active mode, entering the geofence triggers the app to transmit a wireless greeting signal to the sensing unit. (A “query” signal and a “greeting” signal may be of similar nature; the terminology is used for convenience in distinguishing signals sent by a sensing unit from those sent by a mobile-device-resident app).

Thus, in passive mode the app (which may have previously been in a condition in which it would not receive or respond to a wireless query signal from the sensing unit) is triggered into a condition in which it can receive, recognize, acknowledge and/or respond to a query signal from the sensing unit. In active mode the app is triggered to actively transmit a wireless greeting signal to the sensing unit. Regardless of which mode is used, once a query and/or greeting signal is received, the app and the sensing unit can perform the usual operations, e.g. acknowledgement of signal, confirmation of identity, electronic handshake, and so on, in order to establish communication to the point that the data stored on the sensing unit can be transferred to the app.

In some convenient embodiments, the app may be configured so that when the mobile device is outside the geofence, the app can be maintained in a first state in which the app may be essentially dormant except for e.g. a geofencing functionality that works in concert with the location services of the mobile device. In some embodiments, this first state may be a closed state in which the app is not visible on the foreground of the mobile device and is not visible among the set of background-running apps (e.g. as accessed in the App Switcher screen of an iPhone) of the mobile device. That is, when in a closed state the app is not in an open/foreground state or an open/background state.

Thus in some embodiments the app may be maintained in a first state that is a closed state from which the app can be activated (e.g. momentarily opened into an open/background state) by the geofencing functionality upon the geofencing boundary being entered. In other embodiments, such a first state may be an open/background state, meaning that the app is visible among the set of background-running apps if the set is accessed by the user. Such arrangements may depend on the configuration and capabilities of the particular mobile device on which the app is used.

Regardless of the exact nature of the first state, in some embodiments, detection that the geofence of a specified building unit has been entered can trigger the app to be activated from a first, less active state into a second, more active state. In this second state, the app may actively attempt (e.g. for a specified period of time) to establish communication with the sensing unit; and/or, it may passively listen for a query signal from the sensing unit, as mentioned above. Thus in some embodiments, entering the geofenced area can trigger the app to emit a wireless signal using e.g. Bluetooth Low Energy (BLE) or any other suitable low-range (e.g. wireless personal area network (WPAN)) protocol. This attempt to communicate with the sensing unit can occur immediately after entering the geofence, or after a selected time interval.

If the mobile device is located sufficiently close to an HVAC inlet or outlet of the building unit, the signal emitted by the mobile device can enter the HVAC ducting and travel to the sensing unit. Upon the sensing unit receiving the signal (e.g. after e.g. an initial handshake or identity confirmation) and two-way communication having been established, the sensing unit can then transmit whatever data has been stored in the memory of the sensing unit since the last data transfer, to the app. The app can then process the data; or, in many convenient embodiments the app can wirelessly pass the data onward to a remote unit (e.g. a cloud-resident server) 60 as indicated in exemplary embodiment in FIGS. 1 and 2.

It will be appreciated that such arrangements do not necessitate that the sensing unit be capable of communicating with any entity other than the mobile device (i.e., the sensing unit need not be able to communicate with a cloud-based server). Such arrangements can advantageously allow the sensing unit to be maintained in a low-power-consumption condition e.g. in which all it does is periodically obtain and store data (e.g. pressure data) relative to the air filter condition, and listen for a wireless signal from the mobile device (and, optionally, occasionally emit a query signal as discussed herein), until such time as the sensing unit can transmit the stored data to the mobile device. Such arrangements allow the sensing unit to have an acceptably long lifetime (e.g. months) with a relatively small, lightweight, low-cost battery.

After the data has been transmitted from the sensing unit to the app (and, if desired, after confirmation that the data has been successfully received by the app), the data can be cleared from the memory of the sensing unit. The app can then return to its first, less active state. If the geofencing functionality does not observe a subsequent geofencing entry (e.g. if the mobile device remains within the building unit) the app can be maintained in the first state indefinitely if desired. A subsequent entry into the geofence can trigger another activation of the app from the first state to the second state in which the app is able to communicate with the sensing unit and receive data therefrom. In some embodiments the app may be configured so that if the geofencing boundary is reentered a short time (e.g. a few minutes) after a previous data transfer, the app will remain in the first state. In such embodiments a timer may be set so that entering the geofencing boundary causes the app to awaken into the second state only if a predetermined time period (e.g. one hour) has elapsed since the previous data transfer.

In some modes of operation, if the app receives no response from the sensing unit upon entry of the mobile device into the geofenced area, the app may revert to the first state rather than continuing to attempt to contact the sensing unit. In various embodiments, the reversion into the first state may take place e.g. after 1, 2, 5, 10, or 20 minutes of attempted contact with the sensing unit. In some embodiments, if the app receives no response from the sensing unit upon entry of the mobile device into the geofenced area, the app may remain in a state in which it waits to receive a query signal from the sensing unit. Such arrangements may depend on (e.g. may be constrained by) the particular mobile device and operating system.

In various embodiments, any or all of the above-described operations may occur without any need for action on the part of the user. Indeed, in many embodiments they may occur without the user needing to be aware that the operations are occurring. That is, in some embodiments, when the app is in the more-active second state and is communicating with the sensing unit or with a cloud-based server, the app may remain in an open/background state rather than launching into an open/foreground state. This can be true whether the first, less-active state of the app is a closed state or is an open/background state. In the first instance, the app can be awakened to a second, more active state long enough to perform the communication (and may or may not be momentarily visible among the set of open/background apps during this time), after which the app is automatically closed back into the first state. In the second instance, the app will already be running in background and will remain running in background during and after the communication.

Thus depending e.g. on the configuration of the mobile device and operating system, in some embodiments, when the app is in the second, more-active state it may not be visible among the set of open/background apps that are visible on request by the user (e.g. by way of the user double-clicking the home button of an iPhone 8 to view the App Switcher). Or, in other embodiments, when the app is activated into the second state, the app may be visible among the set of open/background apps for a short time and then may disappear, unnoticed unless the user happens to check the list of background-running apps during this time. In still other embodiments the app may be constantly visible (upon user request) among the set of open/background apps, regardless of whether the app is in its first or second state. Regardless of these possible variations, in many embodiments the app will not be visible in the foreground of the mobile device during these operations and thus all of the above-described operations of establishing communication, transferring data, and so on, will be transparent to the user unless, for example, the user deliberately checks the status of background-running apps. Of course, if desired, the app can be configured so that the user receives a notification that the app has been momentarily activated or opened.

As noted earlier herein, in some instances the app may open communication with the sensing unit in a passive manner rather than an active manner. That is, in some embodiments the sensing unit may be the entity that actively sends a (query) signal to initiate communication. For example, the sensing unit may be configured to send out a query signal at suitable intervals (e.g. once per hour). Thus in some embodiments, if the mobile device enters the geofence or remains within the geofence for an extended period of time, the app may not actively send a greeting signal to the sensing unit but rather may open communication with the sensing unit merely by e.g. activating the app into a state in which it is waiting to receive a query signal from the sensing unit. If a query signal is received by the app, communication may be then established in the general manner described above, the app may receive data from the sensing unit, and so on.

The above discussions have primarily concerned embodiments in which an app can be maintained in a first, less-active state (e.g. a closed state) and can be triggered into a second, more active state in which the app can communicate with a sensing unit. After communication, the app can return to the first, less active state. While such arrangements may be particularly convenient in terms of transparency to the user, battery life, and so on, in some embodiments it is not necessary for the app to be brought into a different state (e.g. from a closed state to an open/background state) in order to achieve such communication. Thus in some embodiments, a user may choose to maintain the app in an open/background state; in such a case, entering the geofence may trigger the app to send a greeting signal to the sensing unit, with the app remaining in the open/background state. Similarly, if user chooses to maintain the app in an open/foreground state, entering the geofence can trigger the app to send a greeting signal to the sensing unit, with the app remaining in the open/foreground state. With the app in an open/foreground state, the user may of course interact with the app in any desired manner (e.g., pair the app with a new sensing unit, change profile settings, etc.). After communications are complete the app can remain in that particular state. The particular mode of operation of the app may thus depend on whether a user chooses to keep the app in an open/foreground state, an open/background state, or a closed state. Such variations will be easily understood by those of skill in the art of mobile device operating systems, app development, etc.

It will be appreciated that the location services of the mobile device need to be at least periodically enabled to allow the geofencing function to operate. In some embodiments, the app may be configured to function (that is, to open communications with the sensing unit and receive data therefrom, and so on) even with the geofencing functionality turned off or with the location services disabled. For example, in some embodiments the app can be configured so that when the app is in an open/background or open/foreground state, the app will constantly wait for a query signal from the sensing unit, will respond to such a signal, and so on. Thus, as long as the user occasionally (while in the building unit) opens the app for long enough to receive a query signal from the sensing unit, the necessary data transfer can be achieved. This might entail, for example, the user leaving the app open for an hour or two each day (or once every few days) while in the building unit. The frequency at which the sensing unit sends out a query signal can of course be set to facilitate or optimize this mode of communication. Such a mode of functioning may be used in an ancillary manner (e.g. as a backup-mode) to the geofencing-enabled mode of operation.

The app may be configured in any of the above-described arrangements. As noted, regardless of the particular arrangement, an advantage of the disclosures herein is that after an app and a sensing unit are initially paired, they can act in combination to monitor an air filter without any action or even awareness on the part of the user, unless the user so chooses. In fact, even when the accumulated data indicates that the monitored air filter is approaching the end of its useable filter life, the app need not necessarily be brought to an open/foreground state. Rather, in some embodiments the app may generate an indication signal (e.g. a text, email, alert, or the like) that is displayed on the foreground screen of the mobile device whether or not the app itself is foreground-displayed. However, in other embodiments an conclusion that the air filter is approaching the end of its useable filter life may cause the app to be activated into an open/foreground state.

For brevity, the above discussions do not discuss details of the processes of activating a newly-obtained sensing unit, pairing the sensing unit with the app, and so on. Such topics are discussed in detail in the patent applications previously mentioned (and incorporated-by-reference) herein, which are referred to for this purpose. Although discussions herein have primarily concerned the use of Bluetooth (e.g. Bluetooth Low Energy) wireless communication, it will be appreciated that any suitable WPAN communication method or protocol (e.g. IrDA, Wireless USB, Bluetooth, or ZigBee) may be used, as long as the wavelength is such that the HVAC ducting is able to act as a waveguide for the electromagnetic signals. Although it has been found that the 2.4 GHz wavelength seems well suited, it is possible that other (e.g. higher frequency/shorter wavelength) wavelengths might be usable in similar manner.

Still further, it is noted that the arrangements disclosed herein do not necessitate the presence of any added device to enable a wireless signal from the mobile device to be introduced into the ductwork and do not require or include the presence of any added device to enable a wireless signal from the sensing unit to be propagated out of the ductwork. For example, these arrangements do not require the use of an added device such as an antenna, a coupler, a repeater, an impedance matching device, a reflector, an amplifier, a re-radiator, or a transmitter. Rather, the sensing unit need merely be positioned within the HVAC ducting in the general manner described above. Finally, it is noted that a notification that a filter has reached the end of its “useable filter life” does not necessarily mean that the filter cannot still perform a useful filtering function. Rather, such an notification may merely indicate that the filter is no longer performing as efficiently as it once did; the choice of whether to replace the filter at any given time is left to the user.

### LIST OF EXEMPLARY EMBODIMENTS

Embodiment 1 is a method of monitoring the condition of an air filter installed in an HVAC system of a building unit, the method comprising: performing two-way wireless communication between a sensing unit that is mounted within the HVAC system in a location proximate an air filter that is installed within the HVAC system in a machinery space of the building unit, and a geofencing-enabled app that is resident on a mobile device that is present in an occupied space of the building unit, wherein wireless signals sent from the sensing unit to the mobile device, and wireless signals sent from the mobile device to the sensing unit, pass through an interior passage of ducting of the HVAC system with the interior passage of the ducting acting as a waveguide that allows transmission of the wireless signals between the machinery-spaced-located sensing unit and the occupied-space-located mobile device, and, wherein the geofencing-enabled app is configured so that the app is triggered to open communication with the sensing unit upon the mobile device entering a geofencing boundary that is at least generally coincident with lateral boundaries of the building unit.

Embodiment 2 is the method of embodiment 1 wherein the sensing unit comprises a pressure sensor and is located downstream of the air filter, between the air filter and a blower fan of the HVAC system.

Embodiment 3 is the method of any of embodiments 1-2 wherein the sensing unit comprises a Bluetooth Low-Energy radio transmitter/receiver that sends and receives wireless signals.

Embodiment 4 is the method of any of embodiments 1-3 wherein the sensing unit is mounted on a downstream face of the air filter and is self-powered by a battery.

Embodiment 5 is the method of any of embodiments 1-4 wherein the machinery space is located in a basement, crawl space, attic or utility closet of the building unit and wherein the mobile device is located in an occupied space that is located at least generally upward or downward from the machinery space and is separated therefrom by at least one floor and/or one wall of the building unit.

Embodiment 6 is the method of any of embodiments 1-5 wherein the ducting of the HVAC system through which the wireless signals pass is air-return ducting; wherein the wireless signals sent from the sensing unit to the mobile device exit the HVAC ducting and enter the occupied space by passing through a grille located at an air-return inlet of the air-return ducting; and, wherein the wireless signals sent from the mobile device to the sensing unit leave the occupied space and enter the HVAC ducting by passing through the grille located at the air-return inlet of the air-return ducting.

Embodiment 7 is the method of any of embodiments 1-6 wherein the ducting of the HVAC system through which the wireless signals pass includes air-delivery ducting; wherein the wireless signals sent from the sensing unit to the mobile device exit the HVAC ducting and enter the occupied space by passing through a register located at an air-delivery outlet of the air-delivery ducting; and, wherein the wireless signals sent from the mobile device to the sensing unit leave the occupied space and enter the HVAC ducting by passing through the register located at the air-delivery outlet of the air-delivery ducting.

Embodiment 8 is the method of embodiment 7 wherein the wireless signals that pass through the air-delivery ducting also pass through a fan compartment and through a heat-exchange compartment of a combustion furnace, an electrical heater, or a heat pump, of the HVAC system.

Embodiment 9 is the method of any of embodiments 1-8 wherein the triggering of the app to open communication with the sensing unit upon the mobile device entering the geofencing boundary, comprises triggering the app to wait to receive a wireless query signal from the sensing unit.

Embodiment 10 is the method of any of embodiments 1-9 wherein the triggering of the app to open communication with the sensing unit upon the mobile device entering the geofencing boundary, comprises triggering the app to transmit a wireless greeting signal to the sensing unit.

Embodiment 11 is the method of any of embodiments 1-10 wherein the geofencing-enabled app is configured so that if the app is in a closed state, upon the mobile device entering the geofencing boundary the app is triggered to activate from the closed state into a second, more-active state in which it transmits the wireless greeting signal to the sensing unit, with the proviso that the second, more-active state is not an open/foreground state.

Embodiment 12 is the method of any of embodiments 1-11 wherein when two-way wireless communication between the app and the sensing unit is established, data relating to the condition of the air filter is transmitted from the sensing unit to the app.

Embodiment 13 is the method of embodiment 12 wherein after the data transmission is complete the app reverts to the closed state and remains in the closed state until 1) the mobile device exits the geofencing boundary and then re-enters the geofencing boundary, at which time the app is again triggered to activate into the second, more active state; or, 2) the user manually opens the app to an open/foreground state or to an open/background state.

Embodiment 14 is the method of any of embodiments 11-13 with the proviso that the second, more-active state is not an open/background state.

Embodiment 15 is the method of embodiment 10 wherein the geofencing-enabled app is configured so that if the app is in an open/foreground state or an open/background state, upon the mobile device entering the geofencing boundary the app is triggered to remain in its current state and to transmit a wireless greeting signal to the sensing unit.

Embodiment 16 is the method of any of embodiments 1-15 wherein the geofencing-enabled app is configured so that a user of the mobile device can manually launch the app from a closed state into an open/foreground state.

Embodiment 17 is the method of any of embodiments 1-16 wherein the sensing unit is configured to send a wireless query signal at pre-selected time intervals to attempt to establish wireless communication with the app.

Embodiment 18 is the method of embodiment 17 wherein the geofencing-enabled app is configured so that if the app is in an open/foreground state or an open/background state, the app waits to receive a wireless query signal from the sensing unit.

Embodiment 19 is the method of any of embodiments 1-18 wherein the geofencing boundary is at least substantially coincident with lateral boundaries of the building unit.

Embodiment 20 is the method of any of embodiments 1-19 wherein the geofencing-enabled app is configured so that the geofencing boundary comprises a radius of from at least 10 meters to at most 30 meters.

Embodiment 21 is the method of any of embodiments 1-20 wherein the method does not require or include the presence of any added device to enable a wireless signal from the mobile device to be introduced into the ductwork and does not require or include the presence of any added device to enable a wireless signal from the sensing unit to be propagated out of the ductwork.

### EXAMPLES

Sensing units were produced of the general type disclosed in U.S. Provisional Patent Application No. 62/374,040. The sensing units comprised a pressure sensor and a Bluetooth Low Energy radio transmitter/receiver operating at approximately 2.4 GHz. Each sensing unit was mounted on the downstream face of an air filter of the general type available from 3M Company, St. Paul, Minn., under the trade designation Filtrete (e.g., Filtrete Air Filter MPR (Microparticle Performance Rating) 1500), to form an assembly of the general type available from 3M Company under the trade designation Filtrete Smart Air Filter 1500.

HVAC Waveguide Effect

In a first data-collection study, the assemblies were provided to volunteers and were installed in the HVAC systems of approximately 35 building units. Most of these building units were single-family homes, and encompassed a wide variety of homes, e.g. ranch-style, multi-story, and so on. A wireless RF sniffer was custom built and configured to provide an indication (a green light) of an acceptable RF signal, an indication (a yellow light) of a marginal RF signal, or an indication (a red light) of a poor or absent RF signal.

The RF sniffer was taken into each of the 35 building units in turn and carried throughout the building unit. During periods of time in which the sensing unit was broadcasting using the Bluetooth Low Energy protocol, the RF sniffer was used to gauge the signal strength of wireless signals emanating from the sensing unit. For each building unit, an acceptable signal was found in at least a majority of the occupied spaces of the building unit. In fact, in many of the building units the RF sniffer was deliberately taken into an occupied space that was farthest from the sensing unit (e.g., a bedroom in a far corner of the top floor of a house). In the vast majority of cases, an acceptable signal was still obtained in that location.

Although not being a goal of this study, several of the volunteers took the RF sniffer outside the building unit (e.g. outside of their single-family house) and reported that the RF signal seemed to drop off precipitously even a few feet outside the building unit. This seemed to indicate that the wireless signals could not easily penetrate through walls, and provided further evidence of the advantages of the use of HVAC ducting for distribution of wireless signals throughout the interior of a building unit, in combination with a geofence-enabled app with a geofencing boundary tightly circumscribed around the building unit.

One building unit was selected for a second, more detailed data-collection study. This particular building unit was a single-family home in which the filter and sensing unit were installed in an air-return trunk located in a basement machinery space that was below the occupied spaces of the building unit (which were on the first floor of the home). During periods of time in which the sensing unit was broadcasting using the Bluetooth Low Energy protocol, an RF sniffer (a mobile-device-resident app available under the trade designation BLE PROXIMITY RADAR), was used to detect the signal strength of wireless signals emanating from the sensing unit. The signal was reported in −dB, with a larger number indicating a detected signal of lower strength. By way of baseline, the sensing units were found to emit a signal of about −55 dB when the RF sniffer was held in close, line-of-sight proximity to (i.e. within a few cm of) the sensing unit.

The wireless signal was monitored in a first occupied space (a hallway) that was above, and judged to be approximately vertically aligned with, the filter-mounted sensing unit. The wireless signal strength was approximately −73 dB just outside an air-return inlet that was present in the hallway, and was approximately −87 dB in a location of the hallway that was at least a meter away from the air return inlet. The wireless signal was also monitored in another occupied space (a dining room) that was further away from the filter-mounted sensing unit. The wireless signal strength was approximately −85 dB just outside an air-delivery outlet that was present in the dining room, and was approximately −96 dB in a location (in the center of the dining room) that was a few meters from the air-delivery outlet. The wireless signal was also monitored in another occupied space (a living room), that was farthest from the filter-mounted sensing unit. The wireless signal strength was approximately −86 dB just outside an air-delivery outlet that was present in the living room, and was approximately −96 dB in a location (in the center of the living room) that was a few meters from the air-delivery outlet.

These data demonstrated that at least a substantial preponderance of the wireless signal that was received had been propagated through the HVAC ducting. These data provided further confirmation that even in occupied spaces far from the sensing unit, the HVAC ducting was able to provide a signal that, after exiting the HVAC ducting into an occupied space, was of sufficient intensity to enable acceptable communication (noting that the minimum signal strength to allow acceptable communication between the app and the sensing unit was estimated to be approximately −100 dB).

Geofencing

A geofencing-enabled app was produced of the general type available from 3M Company (e.g. through the Apple App Store, Google Play, or similar software-distribution platform) under the trade designation Filtrete Smart and was distributed to the mobile devices of approximately 20 volunteers. In initial studies, the app was configured for iPhones to which the app was delivered through in-house distribution channels. As the work progressed, the app was expanded to perform on Android devices and was made available through standard software-distribution platforms.

The app, working in conjunction with the location service of the operating system of the mobile device, was configured with a geofencing radius that was not user-adjustable. In initial studies, the geofencing radius was set to approximately 100 meters. As the studies progressed, the geofencing radius was reduced (by the study administrator) to approximately 20 meters, which was judged to be advantageous for reasons which will be clear in view of the disclosures herein. Each volunteer entered the centerpoint of the geofence by entering a street address or by dropping a pin on a map. Each volunteer manually launched the app and paired it with the sensing unit.

Most of the volunteers reported that they typically maintained the app in a closed state (rather than open/background or open/foreground). The geofencing functionality of the app had been configured so that the app would remain in this closed state until the geofencing boundary was entered, which would trigger the app to enter a second, more active state. In the second state the app would attempt to wirelessly contact the sensing unit (i.e. the app would actively send a greeting signal) for a short period of time (e.g. 3-5 minutes). If contact was established, any data that had been collected by the sensing unit (since any previous data transfer) was wirelessly transferred to the app. The app then transmitted the data to a cloud-based server that analyzed the data and generated a measure of the remaining filter life, which was then relayed back to the app. During such activities, the app was not visible in the foreground or the background of the mobile device. After such operations had been completed, the app would return to the first, less active (closed) state.

The app was additionally configured so that if the app was maintained by the user in an open/foreground state or an open/background state, upon entering the geofencing boundary the app would attempt to wirelessly contact the sensing unit, receive data, and so on, while remaining in that state. After such operations had been completed, the app would then remain in that state until such time as the app was closed by the user. The app was configured so that when in an open/foreground or open/background state, it was able to receive a query signal from the sensing unit. The sensing units were configured to send out a query signal once per hour; therefore, as long as the app was kept open and the mobile device remained within range of the sensing unit, the app would receive the query signal and then collect any additional data, at hourly intervals.

The app was additionally configured so that if the geofenced boundary was exited, the app would remain in whatever state (open/foreground, open/background, or closed) the user had chosen to keep the app in. Upon reentering the geofenced boundary, one or more of the above-described operations would be performed again, depending on the particular state that the app was kept in.

The above procedures are described with reference to the app when resident on an iPhone running an IOS operating system. Procedures were similar for the app when resident on an Android device/operating system, except for some differences resulting from differences in the way that the two operating systems handle geofencing. Briefly, if the app was in the open/foreground or open/background state, the app functioned in a similar manner on the two types of devices. However, if the app was in the closed state so that entering the geofencing boundary caused the app to be activated to a more active state in order to attempt to open communication with the sensing unit, an iPhone-resident app could only remain in this activated state for a few minutes. An Android-resident app could remain in this more active state for a longer period of time, e.g. indefinitely.

As noted, the apps were distributed to approximately 20 volunteers, were paired with sensing units, installed in an HVAC system of a building unit, and so on. In the study, the functioning of the apps in conjunction with the sensing units was evaluated. For all of the monitored building units, the actions of the mobile device user (e.g., entering the geofenced building unit, moving around the unit in the course of normal activities, and so on), was found to be sufficient to allow the sensing unit and the app to connect often enough (e.g. at least once per day) to enable sufficient data transfer. (As noted, most of the volunteers apparently kept their app closed most of the time, so these operations were transparent to the users.)

One exception to the above was found to be due to the fact that a volunteer had accidentally positioned the centerpoint of the geofence on the house next door rather than their own house. Once this was corrected the arrangement functioned well. Although inadvertently obtained, this data point further illustrated that the combination of HVAC-borne wireless signals and a geofence-enabled app allowed communication to be triggered only if the mobile-device-resident app was actually brought inside the properly geofenced building unit.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

What is claimed is:

1. A method of monitoring the condition of an air filter installed in an HVAC system of a building unit, the method comprising:
performing two-way wireless communication between a sensing unit that is mounted within the HVAC system in a location proximate an air filter that is installed within the HVAC system in a machinery space of the building unit, and a geofencing-enabled app that is resident on a mobile device that is present in an occupied space of the building unit,
wherein wireless signals sent from the sensing unit to the mobile device, and wireless signals sent from the mobile device to the sensing unit, pass through an interior passage of ducting of the HVAC system with the interior passage of the ducting acting as a waveguide that allows transmission of the wireless signals between the machinery-spaced-located sensing unit and the occupied-space-located mobile device,
and, wherein the geofencing-enabled app is configured so that the app is triggered to open communication with the sensing unit upon the mobile device entering a geofencing boundary that is at least generally coincident with lateral boundaries of the building unit.

2. The method of claim 1 wherein the sensing unit comprises a pressure sensor and is located downstream of the air filter, between the air filter and a blower fan of the HVAC system.

3. The method of claim 1 wherein the sensing unit comprises a Bluetooth Low-Energy radio transmitter/receiver that sends and receives wireless signals.

4. The method of claim 1 wherein the sensing unit is mounted on a downstream face of the air filter and is self-powered by a battery.

5. The method of claim 1 wherein the machinery space is located in a basement, crawl space, attic or utility closet of the building unit and wherein the mobile device is located in an occupied space that is located at least generally upward or downward from the machinery space and is separated therefrom by at least one floor and/or one wall of the building unit.

6. The method of claim 1 wherein the ducting of the HVAC system through which the wireless signals pass is air-return ducting; wherein the wireless signals sent from the sensing unit to the mobile device exit the HVAC ducting and enter the occupied space by passing through a grille located at an air-return inlet of the air-return ducting; and, wherein the wireless signals sent from the mobile device to the sensing unit leave the occupied space and enter the HVAC ducting by passing through the grille located at the air-return inlet of the air-return ducting.

7. The method of claim 1 wherein the ducting of the HVAC system through which the wireless signals pass includes air-delivery ducting; wherein the wireless signals sent from the sensing unit to the mobile device exit the HVAC ducting and enter the occupied space by passing through a register located at an air-delivery outlet of the air-delivery ducting; and, wherein the wireless signals sent from the mobile device to the sensing unit leave the occupied space and enter the HVAC ducting by passing through the register located at the air-delivery outlet of the air-delivery ducting.

8. The method of claim 7 wherein the wireless signals that pass through the air-delivery ducting also pass through a fan compartment and through a heat-exchange compartment of a combustion furnace, an electrical heater, or a heat pump, of the HVAC system.

9. The method of claim 1 wherein the triggering of the app to open communication with the sensing unit upon the mobile device entering the geofencing boundary, comprises triggering the app to wait to receive a wireless query signal from the sensing unit.

10. The method of claim 1 wherein the triggering of the app to open communication with the sensing unit upon the mobile device entering the geofencing boundary, comprises triggering the app to transmit a wireless greeting signal to the sensing unit.

11. The method of claim 10 wherein the geofencing-enabled app is configured so that if the app is in a closed state, upon the mobile device entering the geofencing boundary the app is triggered to activate from the closed state into a second, more-active state in which it transmits the wireless greeting signal to the sensing unit, with the proviso that the second, more-active state is not an open/foreground state.

12. The method of claim 11 wherein when two-way wireless communication between the app and the sensing unit is established, data relating to the condition of the air filter is transmitted from the sensing unit to the app.

13. The method of claim 12 wherein after the data transmission is complete the app reverts to the closed state and remains in the closed state until 1) the mobile device exits the geofencing boundary and then re-enters the geofencing boundary, at which time the app is again triggered to activate into the second, more active state; or, 2) the user manually opens the app to an open/foreground state or to an open/background state.

14. The method of claim 11 with the proviso that the second, more-active state is not an open/background state.

15. The method of claim 10 wherein the geofencing-enabled app is configured so that if the app is in an open/foreground state or an open/background state, upon the mobile device entering the geofencing boundary the app is triggered to remain in its current state and to transmit a wireless greeting signal to the sensing unit.

16. The method of claim 1 wherein the geofencing-enabled app is configured so that a user of the mobile device can manually launch the app from a closed state into an open/foreground state.

17. The method of claim 1 wherein the sensing unit is configured to send a wireless query signal at pre-selected time intervals to attempt to establish wireless communication with the app.

18. The method of claim 17 wherein the geofencing-enabled app is configured so that if the app is in an open/foreground state or an open/background state, the app waits to receive a wireless query signal from the sensing unit.

19. The method of claim 1 wherein the geofencing boundary is at least substantially coincident with lateral boundaries of the building unit.

20. The method of claim 1 wherein the geofencing-enabled app is configured so that the geofencing boundary comprises a radius of from at least 10 meters to at most 30 meters.

21. The method of claim 1 wherein the method does not require or include the presence of any added device to enable a wireless signal from the mobile device to be introduced into the ductwork and does not require or include the presence of any added device to enable a wireless signal from the sensing unit to be propagated out of the ductwork.
